(19) United States
(12) Patent Application Publication
(10) Pub. No.: US 2015/0316078 A1
(43) Pub. Date: Nov. 5, 2015

(54) HYDRAULIC CIRCUIT FOR CONSTRUCTION MACHINES

(71) Applicant: VOLVO CONSTRUCTION EQUIPMENT AB, Eskilstuna (SE)

(72) Inventors: Young-Jin SON, Changwon-si (KR); Seong-Geun YUN, Changwon-si (KR)

(21) Appl. No.: 14/651,469

(22) PCT Filed: Dec. 14, 2012
(86) PCT No.: PCT/KR2012/010933

§ 371 Date: Jun. 11, 2015

(51) Int. Cl. F15B 11/08

(52) U.S. Cl. CPC F15B 11/08; F15B 2211/40553

(57) ABSTRACT

A hydraulic circuit for a construction machine is disclosed, which increases the temperature of hydraulic fluid up to an appropriate level for equipment operation even in a state where an operator does not sit on an operator's seat before starting working during the winter season or the like. The hydraulic circuit for a construction machine includes first and second hydraulic pumps and a pilot pump, a first hydraulic actuator connected to the first hydraulic pump through a first center bypass path, a second hydraulic actuator connected to the second hydraulic pump through a second center bypass path, an operation lever, a main control valve controlling flow directions of the hydraulic fluid supplied from the first and second hydraulic pumps to the first and second hydraulic actuators, respectively, first and second center bypass valves installed to be opened and closed on downstream sides of the first and second center bypass paths in the main control valve, and a switching valve installed to be opened and closed in a signal path between the pilot pump and the first and second center bypass valves.

### TECHNICAL FIELD

The present invention relates to a hydraulic circuit for a construction machine, and more particularly to a hydraulic circuit for a construction machine, which can increase the temperature of hydraulic fluid or the temperature of an engine up to an appropriate level for equipment operation even in a state where an operator does not sit on an operator's seat before starting working during the winter season or in a cold place.

### BACKGROUND OF THE INVENTION

As illustrated in FIG. 1, a hydraulic circuit for a construction machine in the related art includes first and second hydraulic pumps 2 and 3 and a pilot pump 4 connected to an engine 1; a first hydraulic actuator (e.g., an arm cylinder 5 or an optional device cylinder 6) connected to the first hydraulic pump 2 through a first center bypass path 7; a second hydraulic actuator (e.g., a bucket cylinder (not illustrated)) connected to the second hydraulic pump 3 through a second center bypass path 9; a first arm spool 8 installed in the first center bypass path 7 and shifted to control a start, a stop, and a direction change of the arm cylinder 5; a second arm spool 11 installed in the second center bypass path 9 and shifted to make hydraulic fluid from the second hydraulic pump 3 join hydraulic fluid that is supplied from the first hydraulic pump 2 to the arm cylinder 5 through a confluence flow path 10; an optional device spool 12 installed in the first center bypass path 7 and shifted to control a start, a stop, and a direction change of the optional device cylinder 6; a bucket spool 13 installed in the second center bypass path 9 and shifted to control a start, a stop, and a direction change of the bucket cylinder; first and second center bypass valves 14 and 15 installed to be opened and closed on downstream sides of the first and second center bypass paths 7 and 9, and shifted to intercept returning of the hydraulic fluid from the first and second hydraulic pumps 2 and 3 to a hydraulic tank T when being shifted to a closed state, and to return the hydraulic fluid from the first and second hydraulic pumps 2 and 3 to the hydraulic tank T when being shifted to a neutral state; and an operation lever (RCV) lever 16 outputting an operation signal corresponding to an operation amount during an operation by an operator.

In the drawing, an unexplained reference numeral 17 denotes a main control valve (MCV) provided with spools that are shifted by pilot signal pressure supplied from the pilot pump 4 so as to control the hydraulic fluid supplied from the first and second hydraulic pumps 2 and 3 to the first and second hydraulic actuators.

As illustrated in FIG. 1, in the case of performing a work during the winter season or in a cold place, it is required to increase the temperature of hydraulic fluid up to an appropriate level for equipment operation (so called “warming up”) as a preparation work before starting the work. That is, if an operator sits on an operator's seat in a cab, starts an engine, and then upwardly lifts a safety level (not illustrated) that is rotatably mounted in upper and lower directions on the side of the operator's seat, a safety solenoid valve 18 is shifted to an on state. Through this, the operation lever 16 is operated to be shifted to a work preparation stage in which a working device, such as a boom, can be operated.

In this case, in order to increase the temperature of the engine 1 or the temperature of the hydraulic fluid as quickly as possible, pressure of the first and second hydraulic pumps 2 and 3 is maximally increased up to relief pressure, and the operation lever 16 is operated to perform boom-up or arm-in/out so that the hydraulic fluid of the first hydraulic pump 2 and the hydraulic fluid of the second hydraulic pump 3 join together to operate the first and second hydraulic pumps 2 and 3 on the maximum output condition. As a result, the temperature of the hydraulic fluid is increased.

For example, in the case where the operator operates the operation lever 16, pilot signal pressure that is supplied from the pilot pump 4 is supplied to the first and second arm spools 8 and 11 of the main control valve 17 through the safety solenoid valve 18 and the operation lever 16 to shift the first and second arm spools 8 and 11. Through this, the arm cylinder 5 is operated by the hydraulic fluid that is discharged from the first and second hydraulic pumps 2 and 3 and is supplied via the first and second arm spools 8 and 11. In this case, if the arm cylinder 5 is operated at maximum stroke, the hydraulic fluid that is supplied from the first and second hydraulic pumps 2 and 3 to the arm cylinder 5 is relieved to reach the hydraulic tank T via the main relief valve 19 to form the maximum pressure.

In the case where the operator stops the operation of the operation lever 16, the first and second arm spools 8 and 11 of the main control valve 17 is returned to an initial position by an elastic restoring force of a valve spring, and thus the hydraulic fluid from the first and second hydraulic pumps 2 and 3 is returned to the hydraulic tank T along the first and second center bypass paths 7 and 9 of the main control valve 17. That is, load is not generated on the first and second hydraulic pumps 2 and 3, and thus the temperature of the hydraulic fluid is unable to be increased. Due to this, in order to increase the temperature of the hydraulic fluid in the winter season, the operator should continuously maintain the operation of the operation lever 16 in one direction. This may cause the operator to feel a pain in the operator's arm and cause the operator to shiver with cold on the operator's seat before starting the work. In consideration of this, in the case where the operator changes the operation direction of the operation lever 16 to perform arm-out, the driving radius of the arm is increased, and this may cause the operator in the neighborhood of the equipment to be injured.

Further, in order to increase the temperature of the hydraulic fluid or the temperature of the engine to an appropriate level for the work during the winter season, the operator should board the cabin and continuously operate the operation lever 16 for several tens of minutes (e.g., 30 to 40 minutes) in a state where the operator does not perform any special work to cause unnecessary time consumption.

### SUMMARY OF THE INVENTION

Accordingly, the present invention has been made to solve the aforementioned problems occurring in the prior art, and it is an object of the present invention to provide a hydraulic circuit for a construction machine, which can pre-heat hydraulic fluid through increasing of the pressure of a hydraulic pump even in a state where an operator does not board a cabin during the winter season or in a cold place.

It is another objet of the present invention to provide a hydraulic circuit for a construction machine, which does not require an operator's direct operation of a working device to increase the temperature of hydraulic fluid and thus can prevent a safety accident to occur due to an erroneous operation of an operation lever.

### Technical Solution

To achieve the above objects, in accordance with an embodiment of the present invention, there is provided a hydraulic circuit for a construction machine, which includes first and second hydraulic pumps and a pilot pump connected to an engine; a first hydraulic actuator connected to the first hydraulic pump through a first center bypass path; a second hydraulic actuator connected to the second hydraulic pump through a second center bypass path; an operation lever outputting an operation signal corresponding to an operation amount during an operation by an operator; a main control valve having spools which are shifted by pilot signal pressure that is supplied from the pilot pump through the operation of the operation lever so as to control flow directions of hydraulic fluid supplied from the first and second hydraulic pumps to the first and second hydraulic actuators, respectively; first and second center bypass valves installed to be opened and closed on downstream sides of the first and second center bypass paths in the main control valve, respectively, and shifted to intercept returning of the hydraulic fluid from the first and second hydraulic pumps to a hydraulic tank when the first and second center bypass valves are shifted to a closed state; and a switching valve installed to be opened and closed in a signal path between the pilot pump and the first and second center bypass valves, wherein when the switching valve is shifted to an opened state to make the first and second center bypass valves shifted to the closed state by the pilot signal pressure supplied from the pilot pump through the switching valve, the first and second center bypass paths in the main control valve are intercepted, and the hydraulic fluid from the first and second hydraulic pumps, which has been increased up to relief pressure, is returned to the hydraulic tank by a main relief valve of the main control valve.

The switching valve may be an electrical switching valve that is shifted by an electrical control signal input from an outside to open and close the signal path connected to the pilot pump.

The electrical switch may be installed outside a cabin

The electrical switch may be installed inside a cabin.

The switching valve may be arranged on an upstream side of a safety solenoid valve that is shifted to an on state when a safety lever mounted on a side surface of an operator's seat is operated.

The switching valve may be arranged on a downstream side of a safety solenoid valve that is shifted to an on state when a safety lever mounted on a side surface of an operator's seat is operated.

### Advantageous Effect

According to the present invention having the above-described configuration, the temperature of hydraulic fluid or the temperature of an engine can be increased through increasing of pressure of a hydraulic pump up to relief pressure by switch operation, and an operator can take a rest outside a cabin while the hydraulic fluid is pre-heated to provide convenience and reliability. Since a working device operation for pre-heating the hydraulic fluid is not required, a safety accident can be prevented from occurring due to an erroneous operation of an operation lever.

### BRIEF DESCRIPTION OF THE DRAWINGS

The above objects, other features and advantages of the present invention will become more apparent by describing the preferred embodiments thereof with reference to the accompanying drawings, in which:

FIG. 1 is a diagram of a hydraulic circuit for a construction machine in the related art; and

FIG. 2 is a diagram of a hydraulic circuit for a construction machine according to a preferred embodiment of the present invention.

### *Explanation of Reference Numerals for Main Parts in the Drawing

1: engine

3: second hydraulic pump

5: arm cylinder

7: first center bypass path

9: second center bypass path

11: second arm spool

13: spool

15: second center bypass valve

17: main control valve

19: main relief valve

21: switching valve

### DETAILED DESCRIPTION OF THE INVENTION

Hereinafter, a hydraulic circuit for a construction machine in accordance with a preferred embodiment of the present invention will be described in detail with reference to the accompanying drawings.

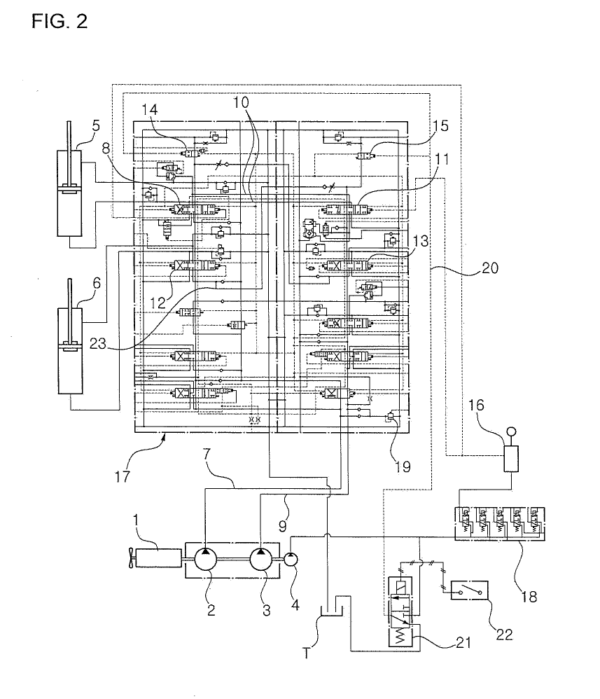

FIG. 2 is a diagram of a hydraulic circuit for a construction machine according to a preferred embodiment of the present invention.

Referring to FIG. 2, a hydraulic circuit for a construction machine according to a preferred embodiment of the present invention includes first and second hydraulic pumps 2 and 3 and a pilot pump 4 connected to an engine 1; a plurality of first hydraulic actuators (e.g., an arm cylinder 5 and an optional device cylinder 6) connected to the first hydraulic pump 2 through a first center bypass path 7; a plurality of second hydraulic actuators (e.g., a boom cylinder and a bucket cylinder (not illustrated)) connected to the second hydraulic pump 3 through a second center bypass path 9; an operation (RCV) lever 16 outputting an operation signal corresponding to an operation amount during an operation by an operator; a main control valve (MCV) 17 having spools 8, 12, 11, and 13 which are shifted by pilot signal pressure that is supplied from the pilot pump 4 through the operation of the operation lever 16 so as to control flow directions of hydraulic fluid supplied from the first and second hydraulic pumps 2 and 3 to the first and second hydraulic actuators, respectively; first and second center bypass valves 14 and 15 installed to be opened and closed on downstream sides of the first and second center bypass paths 7 and 9 in the main control valve 17, respectively, and shifted to intercept returning of the hydraulic fluid from the first and second hydraulic pumps 2 and 3 to a hydraulic tank T when being shifted to a closed state, and to return the hydraulic fluid from the first and second hydraulic pumps 2 and 3 to the hydraulic tank T when being shifted to a neutral state; and a switching valve 21 installed to be opened and closed in a signal path 20 between the pilot pump 4 and the first and second center bypass valves 14 and 15, wherein when the switching valve 21 is shifted to an opened state to make the first and second center bypass valves 14 and 15 shifted to the closed state by the pilot signal pressure supplied from the pilot pump 4 through the switching valve 21, the first and second center bypass paths 7 and 9 in the main control valve 17 are intercepted, and the hydraulic fluid from the first and second hydraulic pumps 2 and 3, which has been increased up to relief pressure, is returned to the hydraulic tank T by a main relief valve 19 of the main control valve 17.

The switching valve 21 may be an electrical switching valve that is shifted by an electrical control signal input from an electrical switch 22 to open and close the signal path 20 connected to the pilot pump 4.

The electrical switch 22 may be installed outside a cabin (not illustrated) so as to pre-heat the hydraulic fluid through switching of the switching valve 21 in a state where an operator does not board the cabin (not illustrated).

The electrical switch 22 may be installed on one side of an operator's seat inside the cabin (not illustrated).

The switching valve 21 may be arranged on an upstream side of a safety solenoid valve 18 that is shifted to an on state when a safety lever (not illustrated) mounted on a side surface of an operator's seat (not illustrated) is operated (i.e., the safety lever is lifted in an upward direction from a bottom surface of the cabin). Through this, an operator can shift the switching valve 21 in a state where the operator does not operate the safety lever to increase the temperature of the hydraulic fluid.

Although not illustrated in the drawing, the switching valve 21 may be arranged on a downstream side of a safety solenoid valve 18 that is shifted to an on state when a safety lever (not illustrated) mounted on a side surface of an operator's seat (not illustrated) is operated (i.e., the safety lever is lifted in an upward direction from a bottom surface of the cabin). Through this, when the operator operates the safety lever to increase the temperature of the hydraulic fluid, the switching valve 21 is shifted in association, whereas when the operator does not operate the safety lever, the switching valve 21 maintains its initial state where the pilot signal path is intercepted.

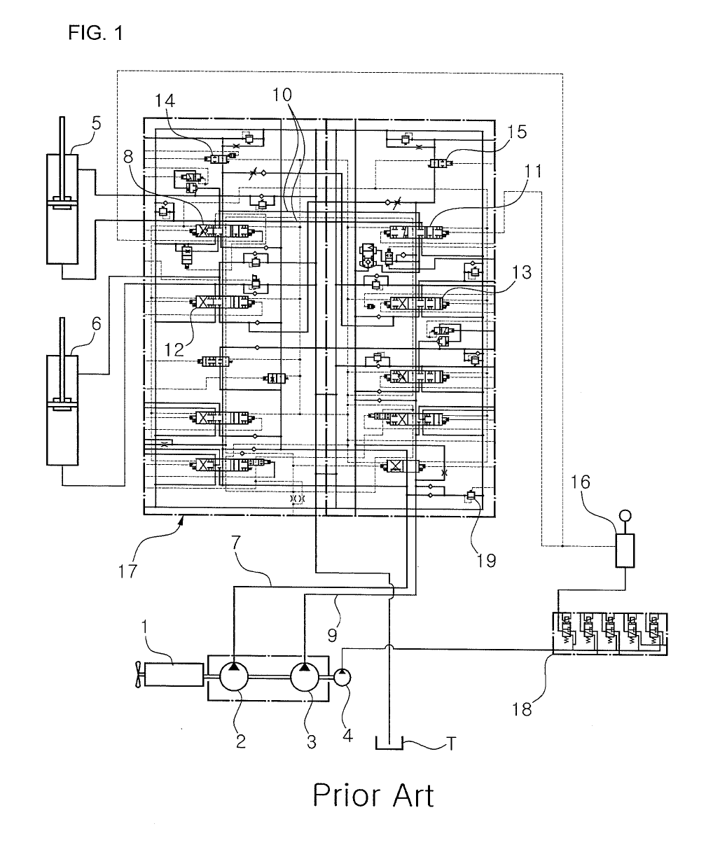

In this case, since the configuration except for the electrical switch 22 and the switching valve 21 that is installed in the signal path 20 between the pilot pump 4 and the first and second center bypass valves 14 and 15 is the same as the configuration of the hydraulic circuit for a construction machine illustrated in FIG. 1, the detailed explanation thereof will be omitted, and the duplicate drawing reference numerals mean the same hydraulic components.

According to the above-described configuration, if the operator does not operate the operation lever 16 in a state where the engine 1 is in start-on state, the spools of the main control valve 17 maintain their neutral state, and the hydraulic fluid that is discharged from the first and second hydraulic pumps 2 and 3 is returned to the hydraulic tank T through the first and second center bypass paths 7 and 9.

On the other hand, if the operator operates the operation lever 16, the spools of the main control valve 17 are shifted by pilot signal pressure that is supplied from the pilot pump 4 corresponding to the operation direction of the operation lever 16. Through this, a working device, such as an arm, can be operated by the hydraulic fluid that is supplied from the first and second hydraulic pumps 2 and 3 to the respective hydraulic actuators.

On the other hand, since the first and second arm spools 8 and 11 for confluence are provided in the main control valve 17, the hydraulic fluid discharged from the first hydraulic pump 2 and the hydraulic fluid discharged from the second hydraulic pump 3 join together by the first and second arm spools 8 and 11 to be supplied to the boom cylinder (not illustrated) or the arm cylinder 5.

In contrast, like the optional device cylinder 6, if the confluence spool is not provided in the main control valve 17, the optional device spool 12 is shifted by the pilot signal pressure that is supplied form the pilot pump 4 when the operation lever (not illustrated) is operated to operate the optional device (breaker or the like). Through this, the hydraulic fluid from the first hydraulic pump 2 moves along the first center bypass path 7, passes through the optional device spool 12, and then is supplied to the optional device cylinder 6. In this case, the pilot signal pressure in accordance with the operation of the operation lever is applied to the second center bypass valve 15 to shift an inner spool in leftward direction in the drawing, and thus returning of the hydraulic fluid that is discharged from the second hydraulic pump 3 to the hydraulic tank T is intercepted.

Accordingly, if the operator who is inside or outside the cabin operates the electrical switch 22 to be in an on state, the inner spool is shifted in a downward direction in the drawing by an input electrical control signal. Through this, the pilot signal pressure from the pilot pump 4 passes through the shifted switching valve 21, moves along the signal path 20, and then is transferred to the first and second center bypass valves 14 and 15.

The spools are shifted by the pilot signal pressure that is transferred to the first and second center bypass valves 14 and 15 to intercept the first and second center bypass paths 7 and 9.

Accordingly, the downstream sides of the first and second center bypass paths 7 and 9 are intercepted in the main control valve 17, and thus the hydraulic fluid that is discharged from the first and second hydraulic pumps 2 and 3 are not returned to the hydraulic tank T, but the pressure of the hydraulic fluid is increased up to the relief pressure that is set by the main relief valve 19.

That is, the hydraulic fluid discharged from the first and second hydraulic pumps 2 and 3, of which the pressure is increased up to the relief pressure, is returned to the hydraulic tank T via the main relief valve 19. Through this, the same effect as the effect, in which the temperature of the hydraulic fluid is increased by maximally increasing the pressure of the first and second hydraulic pumps 2 and 3 as the operator who is sit on the operator's seat operates the operation lever 16 to the maximum stroke, can be obtained during the winter season.

On the other hand, since the switching valve 21 is arranged on the upstream side of the safety solenoid valve 18, the pressure of the first and second hydraulic pumps 2 and 3 can be maximally increased in a state where the safety lever that is mounted on the side of the operator' seat is maintained in a safe state (where the safety lever is positioned on the bottom surface inside the cabin and the working device is unable to be operated even if the operator operates the operation lever 16. Accordingly, it is not required to operate the operation lever so as to pre-heat the hydraulic fluid, and thus a safety accident that may occur due to an erroneous operation of the operation lever 16 can be prevented.

As described above, in the case of performing a work during the winter season or in a cold place, it is not required for the operator to operate the operation lever for a long time in the cold cabin so as to pre-heat the hydraulic fluid, but the operator can pre-heat the hydraulic fluid through maximally heightening the pressure of the hydraulic pump even on the outside of the cabin to solve inconvenience in use. Further, since the hydraulic fluid can be pre-heated even without operator's operation of the operation lever, a safety accident can be prevented from occurring due to an erroneous operation of the operation lever.

Although the invention has been described with reference to the preferred embodiments in the attached figures, it is noted that equivalents may be employed and substitutions made herein without departing from the scope of the invention as recited in the claims.

### INDUSTRIAL APPLICABILITY

According to the present invention having the above-described configuration, in the case of performing a work during the winter season or in a cold place, it becomes possible to increase the temperature of hydraulic fluid or the temperature of an engine up to an appropriate level for equipment operation even in a state where an operator does not sit on an operator's seat before starting the work.

What is claimed is:

1. A hydraulic circuit for construction machine, comprising:
first and second hydraulic pumps and a pilot pump connected to an engine;
a first hydraulic actuator connected to the first hydraulic pump through a first center bypass path;
a second hydraulic actuator connected to the second hydraulic pump through a second center bypass path;
an operation lever outputting an operation signal corresponding to an operation amount during an operation by an operator;
a main control valve having spools which are shifted by pilot signal pressure that is supplied from the pilot pump through the operation of the operation lever so as to control flow directions of hydraulic fluid supplied from the first and second hydraulic pumps to the first and second hydraulic actuators, respectively;
first and second center bypass valves installed to be opened and closed on downstream sides of the first and second center bypass paths in the main control valve, respectively, and shifted to intercept returning of the hydraulic fluid from the first and second hydraulic pumps to a hydraulic tank when the first and second center bypass valves are shifted to a closed state; and
a switching valve installed to be opened and closed in a signal path between the pilot pump and the first and second center bypass valves,
wherein when the switching valve is shifted to an opened state to make the first and second center bypass valves shifted to the closed state by the pilot signal pressure supplied from the pilot pump through the switching valve, the first and second center bypass paths in the main control valve are intercepted, and the hydraulic fluid from the first and second hydraulic pumps, which has been increased up to relief pressure, is returned to the hydraulic tank by a main relief valve of the main control valve.

2. The hydraulic circuit for construction machine according to claim 1, wherein the switching valve is an electrical switching valve that is shifted by an electrical control signal input from an outside to open and close the signal path connected to the pilot pump.

3. The hydraulic circuit for construction machine according to claim 1, wherein the electrical switch is installed outside a cabin

4. The hydraulic circuit for construction machine according to claim 1, wherein the electrical switch is installed inside a cabin.

5. The hydraulic circuit for construction machine according to claim 1, wherein the switching valve is arranged on an upstream side of a safety solenoid valve that is shifted to an on state when a safety lever mounted on a side surface of an operator's seat is operated.

6. The hydraulic circuit for construction machine according to claim 1, wherein the switching valve is arranged on a downstream side of a safety solenoid valve that is shifted to an on state when a safety lever mounted on a side surface of an operator's seat is operated.
